(19) United States
(12) Patent Application Publication
(10) Pub. No.: US 2004/0115465 A1
(43) Pub. Date: Jun. 17, 2004

(54) Composite material comprising a metallic support layer for use in slide bearings

(76) Inventors: Wolfgang Bickle, Reilingen (DE); Werner Schubert, Wiesloch (DE); Thomas Storch, Bruehl (DE)

Correspondence Address: Paul J Vincent, Dreiss Fuhlendorf Steimle & Decker, Postfach 10 37 62, Stuttgart, D-70032, DE

(21) Appl. No.: 10/474,770

(22) PCT Filed: May 31, 2002
(86) PCT No.: PCT/EP02/05994

(30) Foreign Application Priority Data
May 31, 2001 (DE) 101 26 462.3

(51) Int. Cl. F16C 33/20

(52) U.S. Cl. 428/626; 384/908

(57) ABSTRACT

The invention relates to a composite material comprising a metallic support layer a porous carrier layer applied thereto and a PTFE based slide layer that is used as the sliding surface for a sliding partner. The sliding surface material forming the sliding surface also fills out the pores of the carrier layer and comprises at least 60% PTFE by volume and 10-25% zinc sulfide by volume. The sliding surface material further comprises 2-7% PFA by volume and 3-7% PPSO₂ volume.

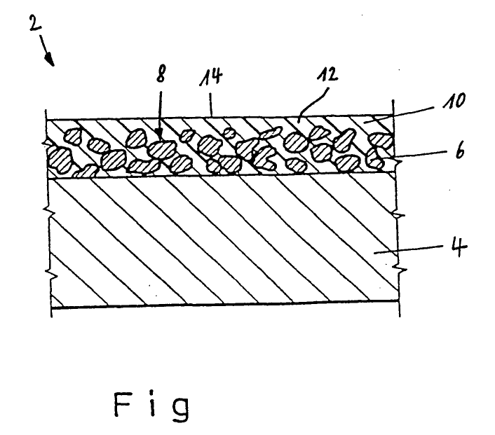

### DESCRIPTION

The invention concerns a sliding bearing composite material with a metallic support layer, a porous carrier layer disposed thereon, and a sliding layer on the basis of PTFE which forms a sliding surface for a sliding partner, wherein the sliding layer material forming the sliding layer also fills the pores of the carrier layer and comprises at least 60 percent by volume of PTFE and 10-25 percent by volume of zinc sulfide.

A sliding bearing composite material of this type is disclosed e.g. in EP 0 232 922 B1. This document, however, does not mention a minimum content of 60 percent by volume of PTFE. For a long time, the Assignee has been producing a sliding bearing composite material which consists of 75 percent by volume of PTFE and 25 percent by volume of ZnS. This patent document also mentions that 5 to 40 percent by volume of aramide fibers, carbon fibers, glass fibers may be additionally contained as fillers.

EP 0 708 892 B1 discloses a sliding bearing composite material which does not disclose all the features characterizing the invention, whose sliding layer material comprises PTFE and 2 to 20 percent by volume of fibrillated aramide fibers. In addition to PTFE, the embodiments also comprise PPS or PFA or calcium fluoride in various portions. This document does not give any further information.

WO 99/45285 discloses a sliding bearing composite material which does not disclose all the features characterizing the invention, whose sliding layer material should comprise PTFE, 10 to 30 percent by volume of a metal fluoride, in particular calcium fluoride and 2 to 10% of fibrillated aramide fibers and 2 to 10% of a meltable fluoropolymer, FEP, PFA or MFA, wherein FEP is preferred. A detailed embodiment is disclosed comprising 4 percent by volume of aramide fibers, 7 percent by volume of FEP, 18 percent by volume of CaF, the rest being PTFE.

WO 99/01675 discloses a sliding bearing composite material whose sliding bearing material comprises at least 60 percent by volume of PTFE, 15 to 25 percent by volume of a metallic filler, preferably lead, and in particular 8 to 12 percent by volume of PVDF and 1 to 3 percent by volume of carbon fibers, oriented in a preferred direction. The use of metallic fillers, in particular lead, has become increasingly unacceptable.

DE 693 27 377 T2 discloses a sliding bearing composite material with metallic support layer and porous carrier layer and a sliding layer, wherein the main component of the sliding layer material is PTFE. Moreover, zinc oxide whisker and magnesium oxysulfate are provided to improve the poor wear resistance of PTFE. In accordance with one embodiment variant, zinc sulfide is mentioned in addition to a large number of other available components. One single embodiment contains PFA in the following composition: 65% by weight of PTFE, 15% by weight of zinc oxide whisker, 5% by weight of MgO and 20% by weight of PFA.

DE 33 43 697 A1 also discloses a sliding bearing composite material with support layer and carrier layer and a sliding layer whose sliding layer material comprises a mixture of the following components: 0.1 to 50 percent by volume of solid lubricants such as metallic lubricants with low melting point including Pb, Sn or alloys thereof, metal oxides, metal sulfides, metal fluorides, graphite or the like, and with fibrous materials such as carbon fibers and ceramics such as SiC, the rest being substantially PTFE, wherein the total content of the components other than PTFE, is within a range of 0.2 to 70 percent by volume.

DE 197 45 667 A1 discloses a polymeric coating system which can also be used for sliding layer applications. It describes compositions with less than 40% by weight of PTFE and more than 30% by weight of PFA and 10 or 20% by weight of PAI and 2.5, 5, 10 or 20% by weight of PPSO₂.

DE 197 28 131 A1 discloses an implantation bearing for artificial joint replacement in humans, wherein PPSO₂ is e.g. suggested as the filler of a base polymer. PTFE is not mentioned as a base polymer.

DE 196 54 102 A1 describes polymeric fluoric mixtures with PTFE and PPSO₂, wherein sliding bearing applications are not mentioned.

In view of the above, the present invention is based on producing a sliding bearing composite material of the above-mentioned type which has a high wear resistance and yet a low coefficient of friction.

This object is achieved in accordance with the invention with a sliding bearing composite material of the present type in that the sliding layer material (10) further comprises 2-7 percent by volume of PFA and 3-7 percent by volume of PPSO₂.

The increase of the wear resistance and maintenance of a low coefficient of friction thereby achieving tribologically suitable properties are, in practice, contradictory objectives. A sliding bearing composite material on the basis of PTFE only has e.g. an excellent coefficient of friction, but the wear resistance is unsatisfactory and can be improved by adding fillers, e.g. metallic fillers. The metallic fillers improve heat dissipation thereby keeping the operating temperatures low which increases the wear resistance.

Moreover, as mentioned above, the addition of fibrous fillers, in particular carbon fibers, is known to increase the coefficient of friction. A high carbon fiber portion, in particular 4 percent by volume and more, increases the wear resistance, however, severely impairs the coefficient of friction. Moreover, the addition of fibrous fillers has the disadvantage that the fibers cannot be held or anchored easily in the sliding layer material and represent potential fatigue locations.

The present invention has shown that optimum results can also be obtained without the addition of fibrous fillers. It has turned out that the addition of PPSO₂ as an abrasion-resistant plastic material reduces wear, i.e. increases the wear resistance. Fixing or embedding of the PPSO₂ particles in the PTFE matrix is optimally supported by PFA.

In accordance with a preferred embodiment of the invention, the sliding layer material comprises 60 to 80 percent by volume of PTFE, in particular 65 to 80 percent by volume of PTFE and preferably 65 to 75% by volume of PTFE.

In accordance with a further embodiment of the invention, the zinc sulfide portion is between 15 and 20 percent by volume.

The average grain size of the zinc sulfide particles used, measured in the centrifugal method according to DIN ISO 9001, is smaller than 1 μm, preferably between 0.2 and 0.5 μm.

A further embodiment of the invention proposes a PFA portion of between 3 and 7 percent by volume, in particular 3 to 6% by volume of PFA, preferably 4 to 6% by volume.

A further embodiment of the invention proposes a PPSO₂ portion of 3 to 6% by volume, preferably 4 to 6% by volume.

Further features, details and advantages of the invention can be extracted from the claims and the following description and drawing of a preferred embodiment of the inventive sliding bearing composite material.

The FIGURE shows a sliding bearing composite material, generally referred to with reference numeral 2, comprising a metallic support layer 4 of steel and a porous carrier layer 6 disposed thereon, preferably of a lead-free bronze layer, e.g. with 90 percent by weight of copper and 10 percent by weight of tin. A sliding layer material 10 is introduced into the pores of the carrier layer 6 on the upper side 8 of the carrier layer 6 opposite to the support layer 4. The sliding layer material 10 projects slightly past the upper side 8 of the carrier layer 6 and forms a sliding layer 12 with a sliding surface 14 for a sliding partner (not shown). The sliding layer material 10 has a PTFE matrix with at least 60 percent by volume of PTFE and 10 to 25 percent by volume of zinc sulfide and, in accordance with the invention, 2 to 7 percent by volume of PFA and 2 to 7 percent by volume of PPSO₂.

A preferred composition of the sliding layer material comprises 60 to 80 percent by volume of PTFE forming the matrix, 10 to 25 percent by volume of ZnS, 3 to 7 percent by volume of PFA and 3 to 7, in particular 4 to 6 percent by volume of PPSO₂.

The sliding layer material preferably consists of the above-mentioned components.

A preferred exemplary composition contains 70 percent by volume of PTFE, 20 percent by volume of ZnS, 5 percent by volume of PFA and 5 percent by volume of PPSO₂.

1. Sliding bearing composite material (2) with a metallic support layer (4), a porous carrier layer (6) disposed thereon, and a sliding layer (12) on the basis of PTFE which forms a sliding surface (14) for a sliding partner, wherein the sliding layer material (10) forming the sliding layer (12) also fills the pores of the carrier layer (6) and comprises at least 60 percent by volume of PTFE and 10 to 25 percent by volume of zinc sulfide,
characterized in that
the sliding layer material (10) comprises also 2-7 percent by volume of PFA and 3-7 percent by volume of PPSO₂.

2. Sliding bearing composite material according to claim 1, characterized in that the sliding layer material (10) comprises 60 to 80 percent by volume of PTFE.

3. Sliding bearing composite material according to claim 2, characterized in that the sliding layer material comprises 65 to 80 percent by volume of PTFE.

4. Sliding bearing composite material, characterized in that the sliding layer material comprises 15-20 percent by volume of zinc sulfide.

5. Sliding bearing composite material, characterized in that the sliding layer material comprises 3 to 7% by volume of PFA.

6. Sliding bearing composite material, characterized in that the sliding layer material comprises 3-6 percent by volume of PPSO₂.

7. Sliding bearing composite material according to claim 6, characterized in that the sliding layer material comprises 4 to 6% by volume of PPSO₂.
